(19) United States
(12) Patent Application Publication
(10) Pub. No.: US 2019/0375338 A1
(43) Pub. Date: Dec. 12, 2019

(54) Cargo Rack System for a Vehicle

(71) Applicant: Nicholas Deninno, Carle Place, NY (US)

(72) Inventor: Nicholas Deninno, Carle Place, NY (US)

(21) Appl. No.: 16/352,713

(22) Filed: Mar. 13, 2019

Related U.S. Application Data
(60) Provisional application No. 62/642,558, filed on Mar. 13, 2018.

(51) Int. Cl. B60R 9/06; B60R 9/12; B60R 9/10

(52) U.S. Cl. CPC B60R 9/06; B60R 2011/004; B60R 9/10; B60R 9/12

(57) ABSTRACT

A cargo rack system for a vehicle 7 with a standard trailer hitch 8. The system includes a rack 2. The rack 2 has a sliding hitch receiver bar 1. The rack is reversible front to back on the sliding hitch receiver bar 1. An extension deck 10 has an aluminum hitch sleeve 11. The extension deck 10 is affixable by the aluminum hitch sleeve 11 directly to the trailer hitch 8. Alternatively the extension deck 10 is affixable by the aluminum hitch sleeve 11 to an end of the rack facing away from the vehicle 7.

The present invention is a cargo rack system for a vehicle. The rack is sized is fit to a specific vehicle type. The presently preferred embodiment of the rack system is sized and shaped to be collapsed and to fit into the internal storage compartment of a Tesla Model X.

With alterations of some of the dimensions, the system can be manufactured to fit other types of Sport Utility Vehicles, and some other types of automobiles. The prototype is being developed for the Tesla Model X, which prototype is therefore the presently preferred embodiment.

The rack system and method of installing it has the following advantages:
The rack is (custom shaped to fit in the vehicle internal storage compartment)
The rack has sliding hitch receiver bar.
The rack is reversible.
The rack can have extension deck, mounted to make the rack larger.
The rack system can mount a bike rack, ski-rack, or other hitch mount accessory.
There is a removable fishing rod adapter.

### BRIEF DESCRIPTION OF THE DRAWINGS

FIG. 1 is an exploded perspective view of a car with a rack positioned behind the car's trailer hitch.

FIG. 1A is a cross section of a hitch mount tube pinned within a trailer hitch.

FIG. 2 is a view similar to FIG. 1 showing an extension deck behind the rack.

FIG. 3 is a rear perspective view showing the rack stowed in the car behind the seats.

FIG. 3A is an oblique rear perspective view showing a rack.

FIG. 3B is an oblique rear perspective view showing a rack, an extension tube, and an extension deck.

FIG. 3C is a cross section of a hitch receiver tube pinned within a trailer hitch.

FIG. 4 is a rear elevation of the rack.

FIG. 5 is a plan view of the rack.

FIG. 5A is a front elevation of the rack.

FIG. 6 is a rear elevation of the extension deck.

FIG. 7 is a plan view of the extension deck.

FIG. 7A is a plan view of the extension deck.

FIG. 8 is an oblique view showing the extension tube.

FIG. 9 is an elevation of a partially threaded anti-rattle hitch pin.

FIG. 10 is an elevation of a quick drop in pin with a cotter pin.

FIG. 10A is an elevation of a clevis pin with a retaining strap.

FIG. 10B is an oblique view of a swivel bar lock.

FIG. 10C is an oblique view of the rack with a fishing rod holder.

FIG. 11 is an oblique view of the extension deck with a fishing rod holder.

FIG. 12 is an oblique view of the rack with a multi-use accessory carrier.

FIG. 13 is a perspective view of the multi-use accessory carrier.

FIG. 14 is a perspective view of the multi-use accessory carrier, and the fishing rod holder.

FIG. 14A is a perspective view of the rack with a cargo bag strapped on.

FIG. 15 is a view of the multi-use accessory carrier folded.

FIG. 16 is a side elevation of the multi-use accessory carrier leaned back.

FIG. 16A is a perspective view of the rack with bike rack mounting arms.

FIG. 17 is a plan view of the accessory carrier carried on the rack.

FIG. 18 is a front elevation of the carrier carried on the rack.

FIG. 19 is a perspective view of a bike rack mounting arm.

FIGS. 20 & 21 are plan views of presently preferred deck surfaces.

FIG. 22 is a perspective view of the carrier.

FIG. 23 is a rear elevation of a slotted of track.

FIG. 24 is a side elevation of the slotted track.

### DETAILED DESCRIPTION OF THE DRAWINGS.

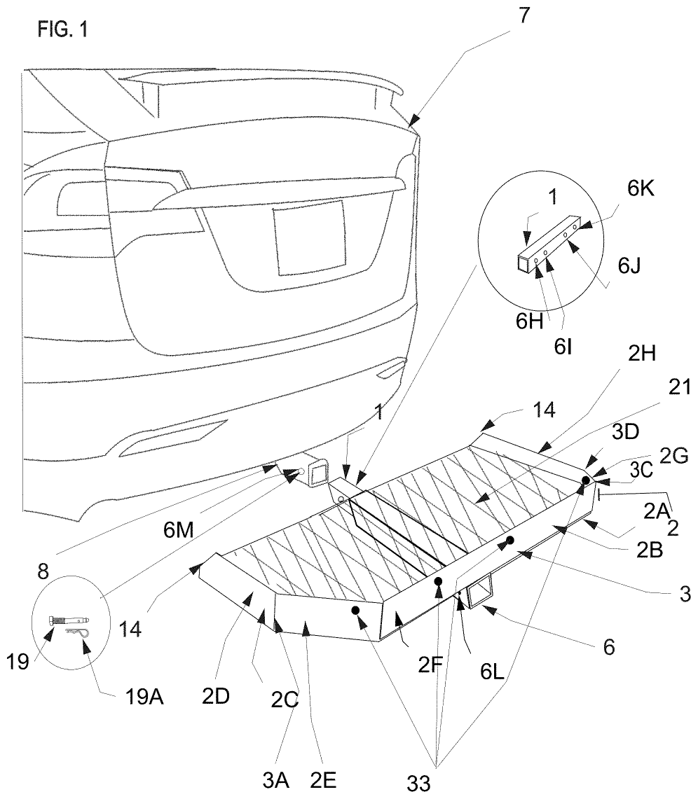

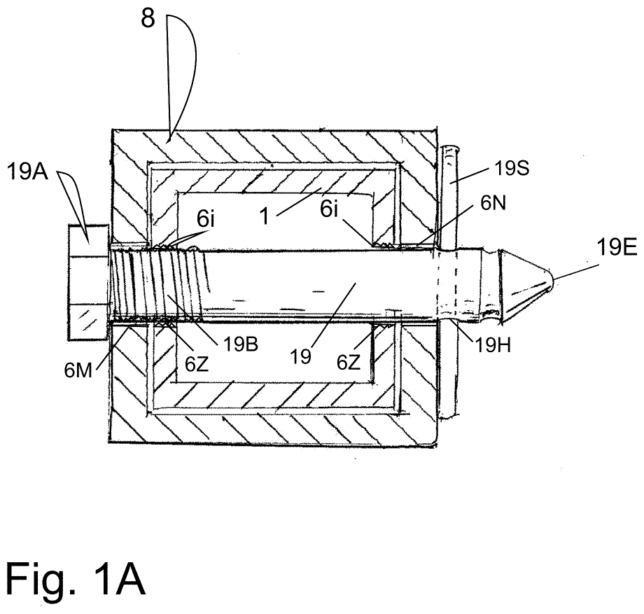

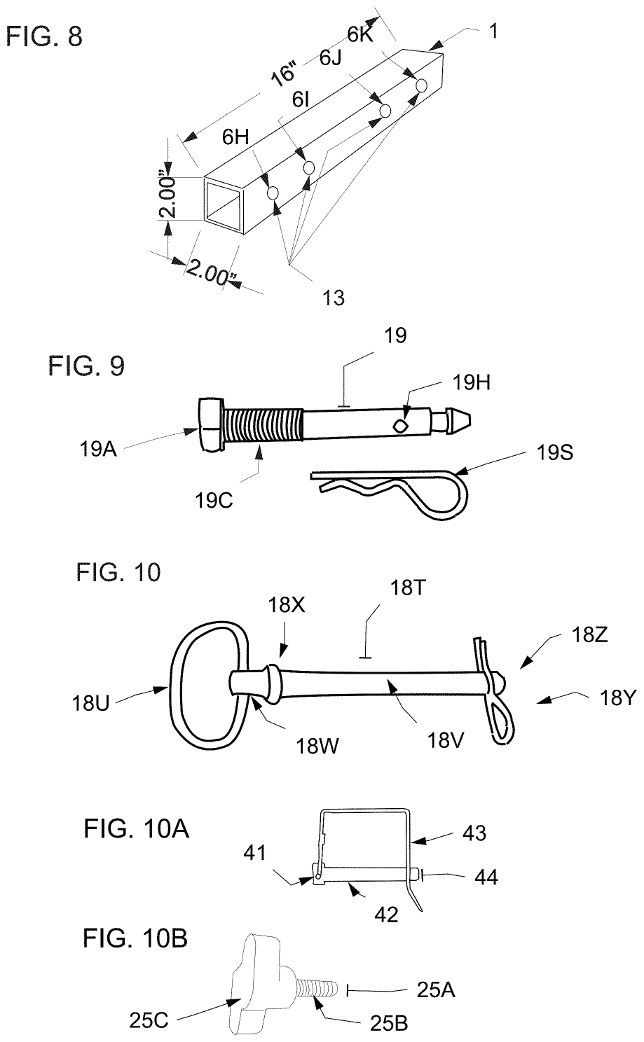

FIG. 1 is an oblique perspective view of the rack system positioned to be mounted on a vehicle. A hitch mount tube 1, extends forward of the rack system, generally designated 2. Hitch mount tube 1 is detailed in the inset, and further shown in FIG. 8.

In FIG. 1 rack system 2 comprises a cargo basket 2A, defined by a substantially vertical perimetric fence 2B.

The perimetric fence 2B comprises an aluminum strip 2C, about 3″ high, bent into several sections:
front left section 2D,
left angled rear section 2E,
rear section 2F,
rear angled right section 2G, and
right section 2H.

The sections 2D-2H are divided by a plurality of bends in the aluminum strip 2C.

Bend 3A is between front left section 2D and left-angled rear section 2E.

Bend 3B is between left angled rear section 2E and rear section 2F.

Bend 3C is between rear section 2F, rear angled right section 2G.

Bend 3D is between rear angled right section 2G, and right section 2H.

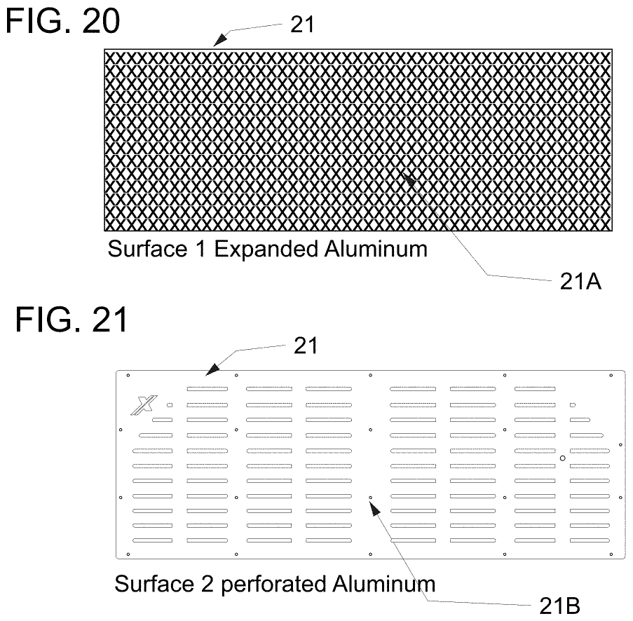

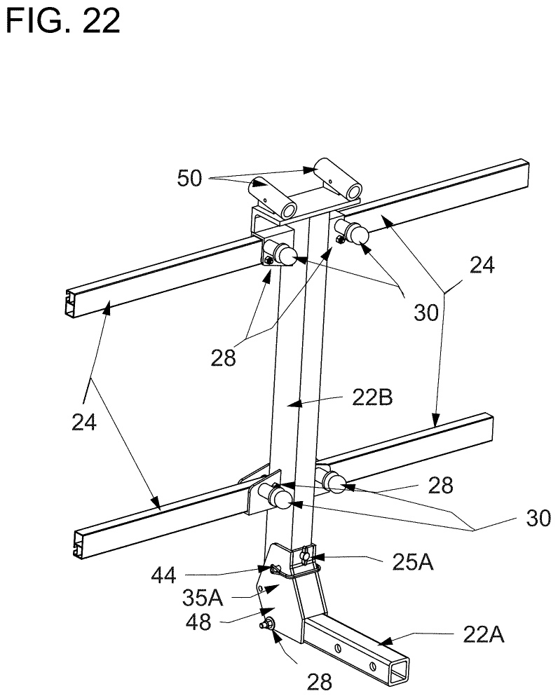

In FIGS. 1-3 the perimetric fence is welded to a floor 21 of aluminum sheet, such as a Standard 3003 Aluminum Expanded Sheet 21A, made from a one-piece construction, having diamond-shaped trusses as shown also in FIG. 20.

A plurality of tie down holes 33 are shown in the fence 2B.

The floor 21 shown is of Aluminum Perforated Sheet 3003 H14, shown in FIG. 21 as perforated sheet 21B.

Cargo basket 2A further comprises an aluminum hitch receiver tube 6 welded below the cargo basket 2A. The hitch mount tube 1, is extended forward from within the aluminum hitch receiver tube 6. The hitch mount tube 1 comprises holes 6H to 6K (See also FIG. 8).

Dimensions are presented to provide a critical fit with the Tesla, but other dimensions will be used to provide a similar fit to other vehicles with different measurements.

Hole 6L in hitch receiver tube 6, is aligned to one of holes 6H to 6K (inset & FIG. 8) and pinned to said hole such as 6i, with a threaded fastener 19 (inset; see also FIG. 9) screwed into matching threads in hole 6L, to pin into the aligned hole such as 6J.

Hole 6M in receiver hitch 8, is aligned to one of holes 6H to 6K and pinned to said hole with another fastener 19. As in FIG. 9, the fastener 19 is screwed by a hex head 19A, in a tightening rotation, screwing threads 19C clockwise into matching threads in the aligned hole such as 6M. Hole 19H is far enough from the head 19A so that hole 19H protrudes from the hitch receiver tube 6, and S-cotter-pin 19S can be inserted into hole 19H, to prevent fastener 19 from unscrewing or falling out.

Returning to FIG. 1, the hitch mount tube 1, now extends forward of the cargo basket 2, towards the vehicle 7. Vehicle 7 is shown as a presently preferred a Tesla Model X. The sliding hitch mount tube 1, is slid into the receiver hitch 8, and pinned or padlocked into place.

An existing trailer hitch, or vehicle receiver hitch 8 extends from the vehicle 7. To install the cargo basket 2 onto vehicle 7, the sliding hitch receiver bar 1 or hitch mount tube 1, is slid into the receiver hitch 8.

In this embodiment, a ⅝″ threaded bolt 19 is slid through the receiver hitch 8, through a ⅝″ hole 12 through the receiver hitch 8, and then threaded into a ⅝″ threaded hole 13 in the sliding hitch mount tube 1. Head 19A of bolt 19 is then wrench tightened to secure the cargo basket 2A to the vehicle 7. A cotter pin 19S is inserted through a hole 19H at the headless end of bolt 19, to prevent loss of bolt 19, in case the threads work loose.

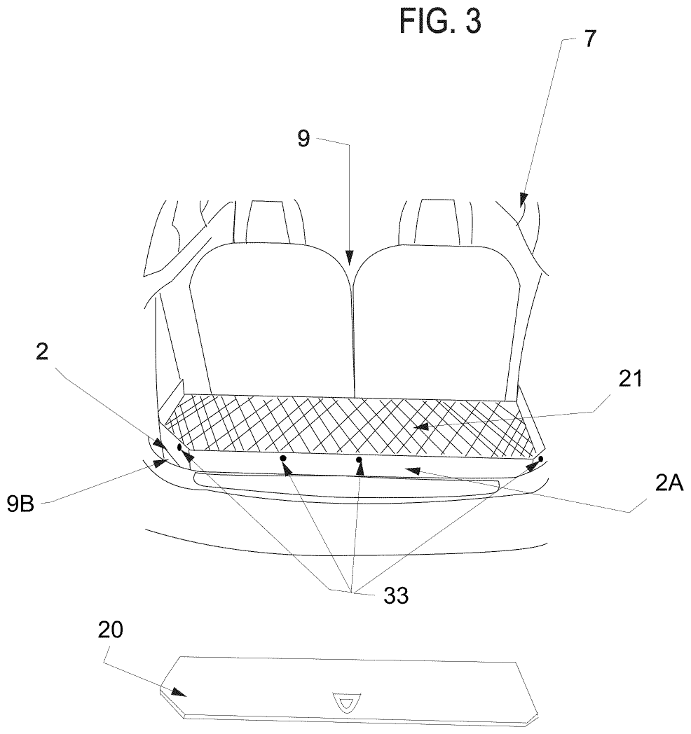

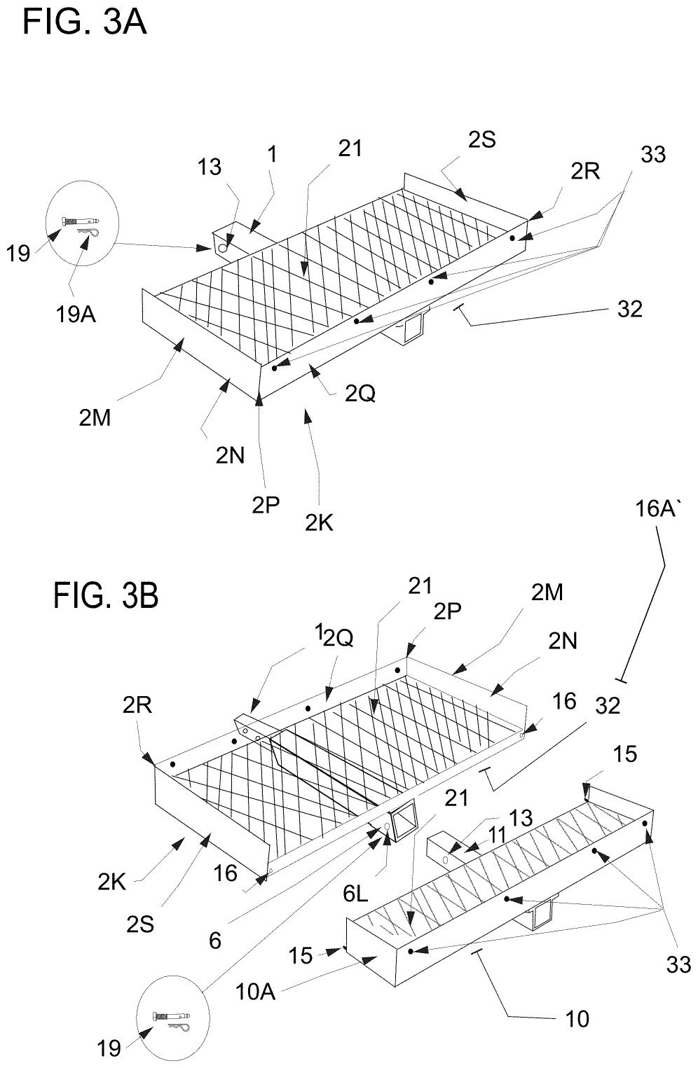

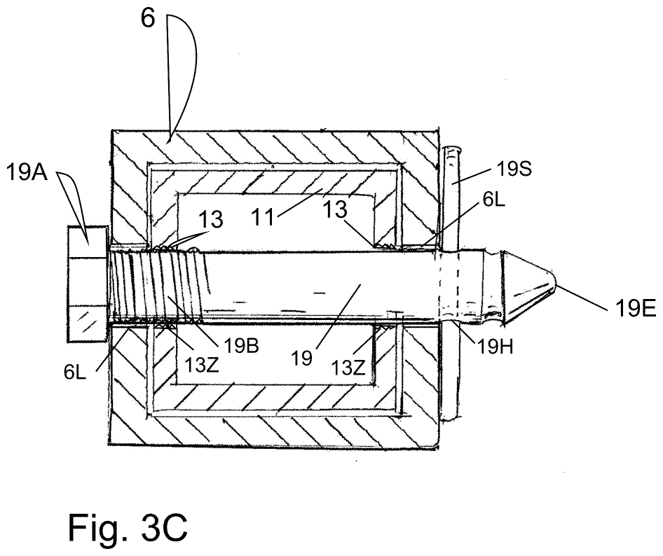

FIG. 3 is a perspective view of the interior of vehicle 7, showing the cargo basket 2, behind rear seats 9, in a storage space 9B.

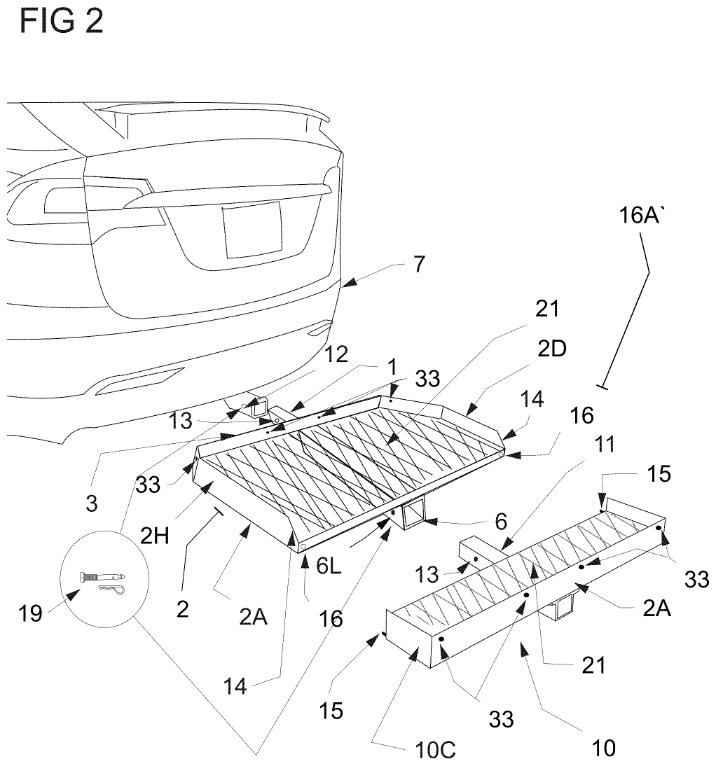

FIG. 2 is an oblique perspective view, similar to FIG. 1, further including a cargo basket extension 10 positioned to be mounted on a vehicle.

An extension deck 10 is affixed to a 2″ aluminum hitch sleeve 11. Hitch sleeve 11 has another ⅝″ threaded hole 13.

An extension perimetric fence 10A comprises an extension aluminum strip 10B, also about 3″ high. Extension aluminum strip 10B is bent into three extension sections:
left extension section 10C, to a left-to-rear bend 10D, bounding,
rear extension section 10E, to a rear-to-right bend 10F, bounding,
right extension section 10G.

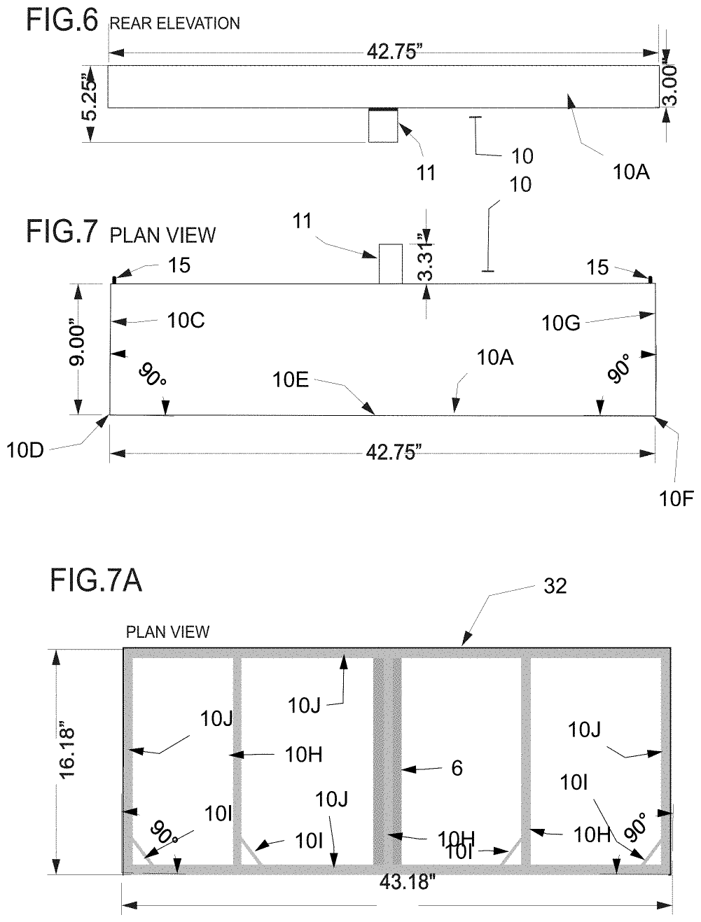

See also FIGS. 6 and 7.

In FIG. 2, the back 2F of rack 2 is turned forward, towards the vehicle 7's receiver hitch 8. The hitch mount tube 1 has been removed from the former front end of the aluminum hitch receiver tube 6 and remounted at the former rear end of the aluminum hitch receiver tube 6, by a ⅝″ threaded bolt 19. Alignment pins 15 protrude from the front of extension deck 10, and align with alignment holes 16 on the unfenced edge of rack 2.

As in FIGS. 1-2, angles 14 have been cut in fence 2A and 2D to fit in the storage space 9B of FIG. 3.

FIG. 2 shows extension deck 10, 2″ aluminum hitch sleeve 11, ⅝″ hole 12, and ⅝″ threaded hole 13.

As in FIG. 3, rack 2 has an angled cut to clear rear seats 14, of FIG. 3.

FIGS. 2 & 3B show alignment pins 15, and alignment holes 16.

FIG. 5A shows Front lower surface 16B

As in FIG. 2, the hitch mount tube 1, again extends forward of the cargo basket 2A, towards the vehicle 7, and towards the vehicle receiver hitch 8, whereto the cargo basket 2 may be mounted on the vehicle 7, and secures by bolt 19.

Rack 2 has alignment holes 16 at rack 2's rear edge. Pins 15 are sized and spaced to fit into alignment holes 16, thereby reinforcing and stabilizing an assembly 16A (shown exploded in FIG. 2) of extension deck 10 to rack 2.

FIG. 3B shows the aluminum hitch sleeve 11 is located to the aluminum hitch receiver tube 6, and then slid into the aluminum hitch receiver tube 6. Pins 15 mate snugly into holes 16, further stabilizing the resulting structure. Another bolt 19 is inserted through rear hole 12, and threaded into threaded hole 13 of extension deck 10. Bolt 19 is wrench-tightened to secure extension deck 10 to rack 2.

FIG. 3A shows an alternative universal embodiment of a rack: universal rack 2K. This embodiment is not shaped to fit any particular car. A universal perimetric fence 2M comprises a universal aluminum strip 2N, also about 3″ high. Universal aluminum strip 2M is bent into three universal sections:
left universal section 2N, to a left-to-rear universal bend 2P, bounding,
rear universal section 2Q, to a rear-to-right universal bend 2R, bounding,
right universal section 2S.

FIG. 3B shows the alternative universal rack 2K, turned around so that rear universal section 2Q is now in front towards the vehicle 7's receiver hitch 8. Universal rack 2K also has an aluminum hitch receiver tube 6. The hitch mount tube 1 has been removed from the former front end of the aluminum hitch receiver tube 6 and remounted at the former rear end of the aluminum hitch receiver tube 6, by a ⅝″ threaded bolt 19. Alignment pins 15 protrude from the front of extension deck 10, and align with alignment holes 16 on the unfenced edge of universal rack 2K, to stabilize the assembled unit of universal rack 2K to extension deck 10.

The aluminum hitch sleeve 11 is located to the aluminum hitch receiver tube 6, and then slid into the aluminum hitch receiver tube 6. Pins 15 mate snugly into holes 16, further stabilizing the resulting assembly of universal rack 2K to extension deck 10. Another bolt 19 is inserted through rear hole 12, and threaded into threaded hole 13 of extension deck 10. Bolt 19 is wrench-tightened to secure extension deck 10 to universal rack 2K.

A plurality of tie down holes 33 are shown in the fences of FIGS. 1 through 3B.

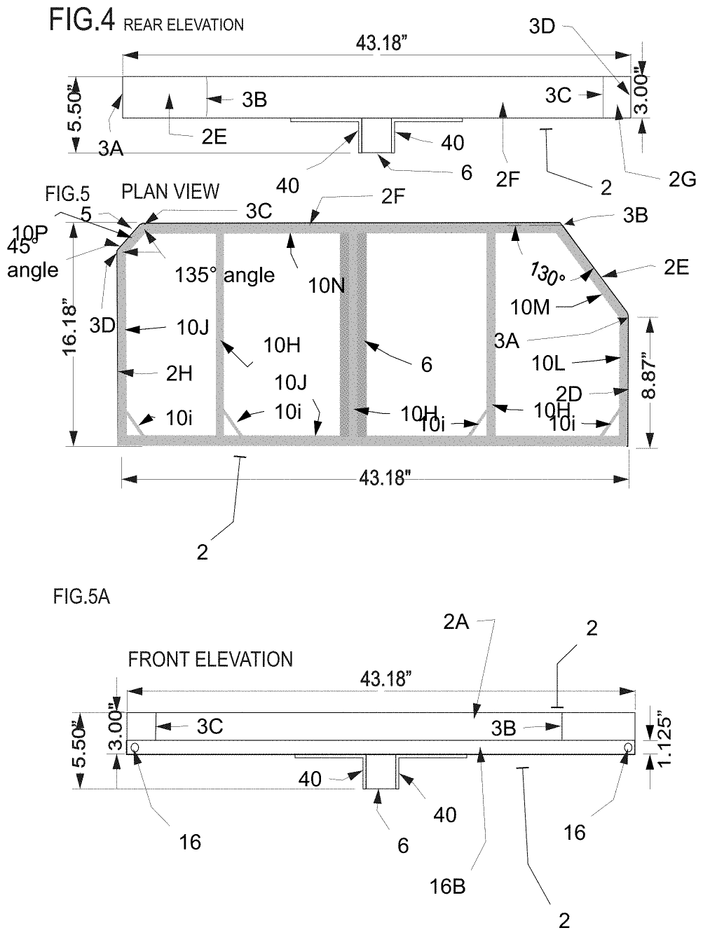

FIG. 4 is a rear elevation of the presently preferred Tesla embodiment of rack 2, showing the fence 2A height of 3″; an overall height of 5.5″, including the aluminum hitch receiver tube 6; and an overall width of 43.18″, a pair of brackets 40 FIGS. 4,5, &5A, are welded to the rack 2 and to the aluminum hitch receiver tube 6, to secure the aluminum hitch receiver tube 6 to the rack 2.

FIG. 5 is a top plan view of the presently preferred embodiment of rack 2. It has a front-to-back platform length of 16.18″; and an overall width of 43.18″. The right side is 8.87″ from stern to angle 3A. Bend 3B forms an interior angle of 130 degrees. Bends 3C and 3D each form an interior angle of 135 degrees. Braces 10H 10i & 10J are shown in FIG. 5.

FIG. 5A is a front elevation of the rack 2. FIG. 5A also shows locating holes 16 in a lower front surface 16B.

FIG. 6 is a rear elevation of extension deck 10. Overall height is only 5.25″ because aluminum hitch sleeve 11 is small enough to sleeve inside aluminum hitch receiver tube 6.

FIG. 7 is a top plan view of extension deck 10. The left side is 9″ from front to back. Aluminum hitch sleeve 11 extends 3.31″ forward of extension deck 10.

FIG. 7A is a top plan view of the universal cargo basket 32 showing braces 10H, 10i & 10J.

FIG. 8 is an oblique view of the sliding hitch mount tube 1, showing threaded holes 13: individually referenced as 6H, 6i, 6J, & 6K.

FIG. 9 is a side elevation of the fastener 19, which is screwed by a hex head 19A, in a tightening rotation, screwing threads 19C clockwise into matching threads in the aligned hole such as 6M. Hole 19H is far enough from the head 19A so that hole 19H protrudes from the hitch receiver tube 6, and S-cotter-pin 19S can be inserted into hole 19H, to prevent fastener 19 from unscrewing or falling out.

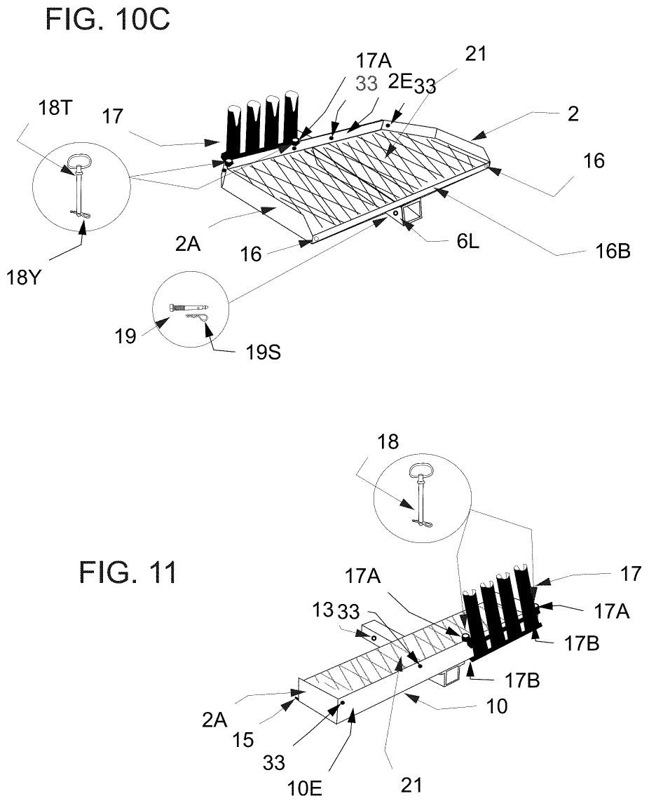

FIG. 10 is an alternative locking pin or ⅜″ clevis pin 18T, including a ring 18U, mounted to a shaft 18V, through a hole 18W. A shoulder 18X stops the pin 18T from passing through a hole it's inserted in. After the pin 18T is in place, cotter pin 18Y secures it.

FIG. 10A shows another locking clevis pin 35, having a latch 36, rotatably mounted by a latch pin 37 to clevis pin 35; forming a locking clevis pin assembly 31.

FIG. 10B is a rotating screw fastener 25A having a machine screw threading 25A driven by wing-nut 25C.

FIG. 10C is an oblique perspective view of the rack 2, having a fishing rod holder 17 mounted on the fence at rear section 2E. The fishing rod holder 17 has a pair of upper mounting rings 17A, and a pair of lower mounting rings 17B. Clevis pin 18T is held by its ring 18U, and then inserted through the pair of upper mounting rings 17A, and through the pair of lower mounting rings 17B.

FIG. 10C shows fishing rod holder 17 on rack 2.

FIG. 11 is an oblique perspective view of the extension deck 10, having a fishing rod holder 18 mounted on the extension deck 10. A cotter pin 18Y is then inserted through a hole 18Z to secure clevis pin 18T and thereby secure rod holder 17:
to fence 2E in FIG. 10B, or
as in FIG. 11, to fence 10E.

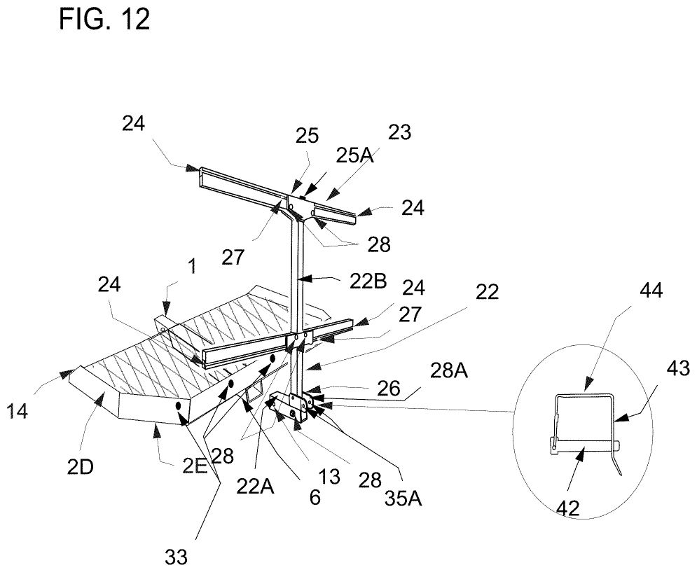

FIG. 12 shows an accessory, a four-arm multi-use accessory carrier 22. A mounting box 22A is sized to fit within the 2″ hitch receiver tube 6. The mounting box 22A is slid into the hitch receiver tube 6 and secured thereto by an anti-rattle hitch pin 19 through a hole in the hitch receiver 6, and threaded by threads 19C (FIG. 9) into threaded hole 13 in the mounting box 22A, then tightened by a wrench, and secured by cotter pin 19S (FIG. 9).

FIG. 12 shows upright 22B is secured to box 22A by pin 19 through threaded hole 28, and further braced up by side plates 28A, and by the pin 35 of pin assembly 31 through holes 35A through side plates 28A. Latch 36 then secures pin 35 in hole 28A. Braces 25 are frictionally secured by adjustable bolts 28 to upright 22B and allow the arms 24 to be positioned and angled as needed.

On the upright 22B and the arms 24 can be mounted a ski rack (by other) fishing pole adapter 17; a cargo bag; or bike rack mount arm 36, the arms fold up in the bottom hinges and lays flat and stores inside cargo basket.

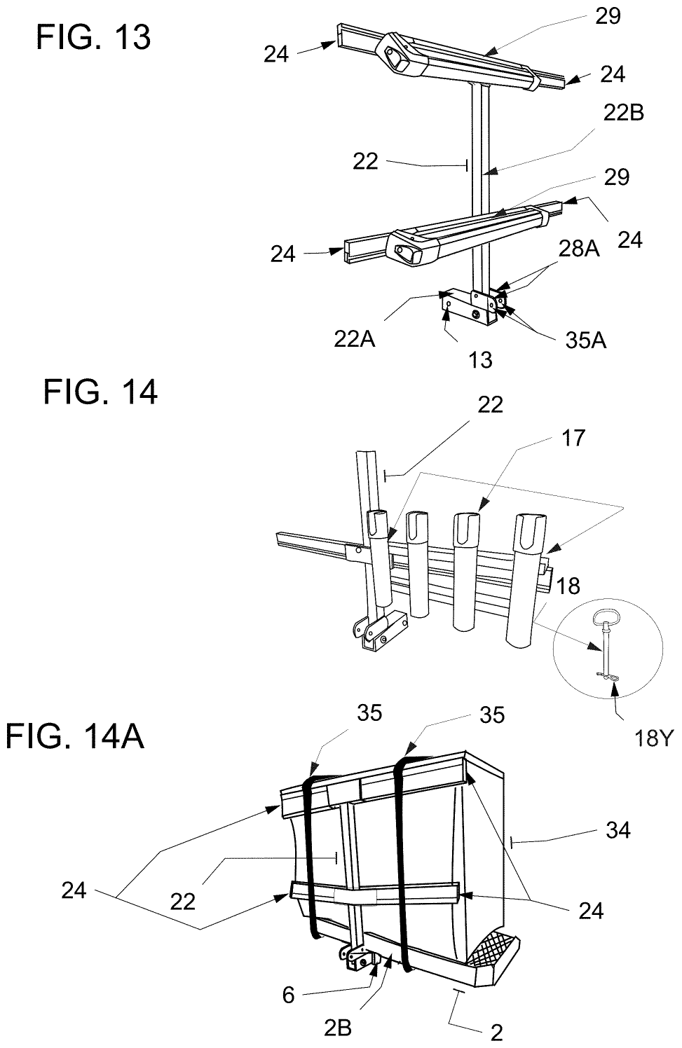

FIG. 13 shows an accessory carrier 29 attached to the arms 24.

FIG. 14 shows another the fishing rod holder 17 attached to the arms 24.

FIG. 14A shows a large storage box 34 on rack 2, secured by straps 35 around arms 24, rack 2 and box 34.

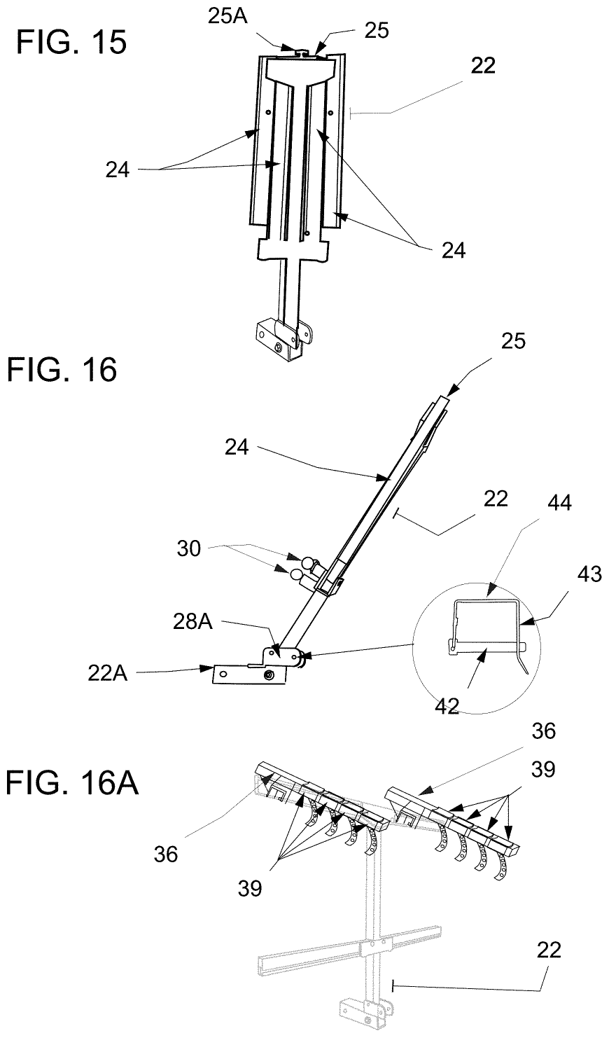

FIG. 15 the four-arm multi-use accessory carrier 22 with its arms folded vertically.

FIG. 16 is a side elevation thereof showing round knobs 30 for adjusting screw tension on the braces 25.

FIG. 16A shows ski racks 36 mounted to upper arms 25 of four-arm multi-use accessory carrier 22.

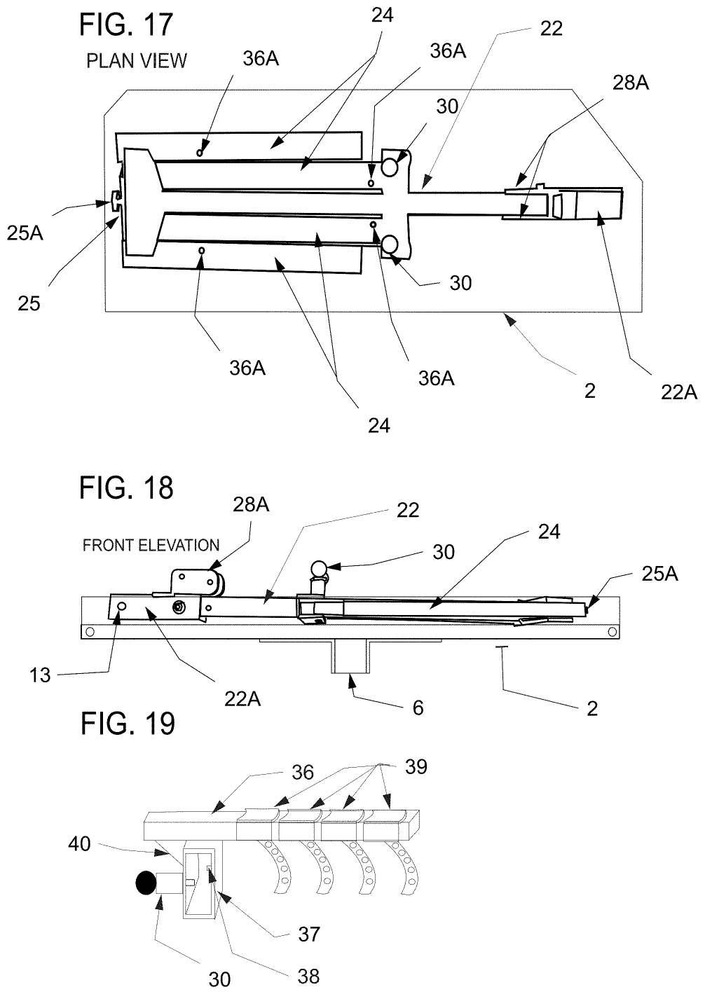

FIG. 17 is a plan view of the four-arm multi-use accessory carrier 22 folded and stored on the rack 2.

FIG. 18 is a front elevation of the four-arm multi-use accessory carrier 22 folded and stored on the rack 2.

FIG. 19 is an oblique view of a ski rack 36. A box 27 fits slidably over arms 24 of FIGS. 12 & 17. Hand adjustable knob screw 30 can be loosened to slide box 37. Protrusion 38 can be slid to and located into a hole 36A (FIG. 17). Screw 30 can be tightened to hold the protrusion 38 in hole 36A, thus securing ski rack 36 in the location.

FIG. 20 shows surface 21 as an expanded aluminum grid.

FIG. 21 shows surface 21 as a perforated aluminum surface.

The invention includes a method of installing the rack comprising the steps of:
Sliding out the retractable hitch mount 1 from the cargo carrier;
inserting the retractable hitch mount 1 into the vehicle receiver hitch 8;
securing the retractable hitch mount 1 into the vehicle receiver hitch 8 by inserting an anti-rattle hitch pin 19 through a hole 12 in the vehicle receiver hitch 8; and
screwing the anti-rattle hitch pin 19 into a threaded hole 13 in the retractable hitch mount tube 1.

The X-Rack is custom made for a Tesla Model X. When not in use the rack 2 may be unmounted, folded, and stored in the Tesla's rear trunk storage well.

The method of uninstalling includes the steps of:
un-screwing the anti-rattle hitch pin 19 from the threaded hole 13 in the retractable hitch mount 1;
sliding the retractable hitch mount tube 1 out of the vehicle receiver hitch 8;
sliding the retractable hitch mount 1 into an aluminum hitch receiver tube 6, thus reducing the footprint of the rack 2; and
storing the rack 2 snugly in the space 9B behind the rear-most seats 9.

The method of uninstalling may further include the steps of:

using the cargo basket 2 to replace the car's rear trunk floor panel 20, and

lifting the cargo basket 2. The cargo basket 2 will lift the same way as the floor panel 20, to yield access to the car's lower storage bin.

The cargo basket 2 also features optional accessories to make travel easier.

The main cargo basket 2 has a standard 2″ receiver hitch and will allow a user to add any standard 2″ receiver bike or ski rack. This gives additional cargo space, and carries bikes or skis at the same time.

There is also an extension deck 10 add-on for the rack, if more cargo space is needed.

There are fishing rod holders 17.

The rack system is made with Aluminum. The aluminum design keeps the rack strong and light weight. The retractable hitch mount tube is made from 2×2× 3/16″ steel or 2×2×¼″ aluminum. The cargo carrier is powder coated for a long-lasting finish.

FIG. 20 shows an expanded aluminum floor 21A of the basket 21.

FIG. 21 shows the presently preferred perforated aluminum floor 21B of the basket 21.

FIG. 22 is a perspective view of the multi-armed accessory carrier 22, mounted on the same square section tubing 6 used in trailer hitches 6.

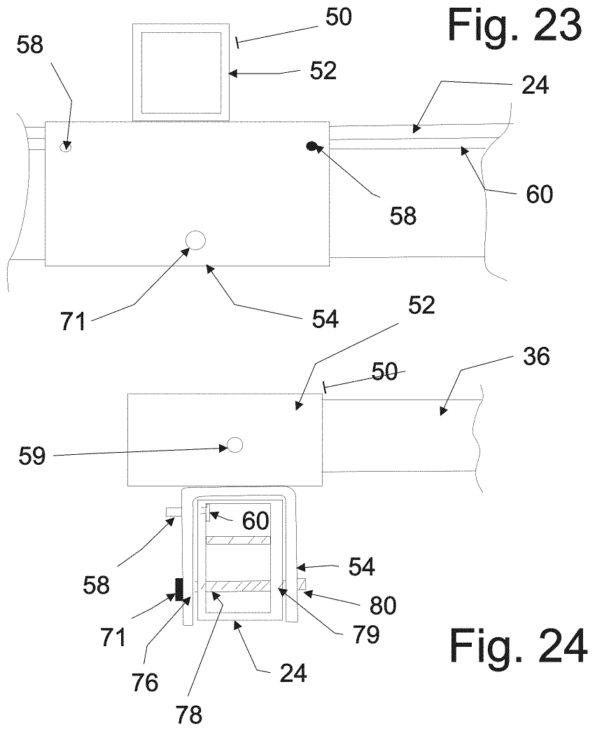

FIGS. 23 & 24 are elevations of a slotted track.

FIG. 22 is a bike rack. From the tube 6, protrudes a horizontal mounting tube 22A. A hinge bolt 28 pivotably secures an upright mounting tube 22B to the horizontal mounting tube 22A. A bracket 48 is welded atop horizontal mounting tube 22A. A clevis pin 44 secures the upright mounting tube 22B vertically. A pair of alternate holes 35A allow the clevis pin 44 to be moved, to secure the upright mounting tube 22B at another angle.

Four arms 24 are mounted horizontally but are pivotable on hinge pins 28, in vertical directions to fold (as in FIG. 15). To fold a lower arm 24 of FIG. 22 up, a spring-loaded pop pin 30 is pulled out toward this photo's right, out of a hole in the arm 24. The lower arm 24 is then free to be folded up against upright 22B. When the lower arm is vertical, the pop pin 30 will be located over a vertical positioning hole 36A (FIG. 17) in the lower arm 24, and the pop pin 30 will pop in.

Bike rack housing 50 is slid onto upper arm 24 and bolted or pinned to one of several cooperatively placed and sized holes in upper arm 24.

An arm of the presently preferred Softride Dura 4 Bike Rack 36 is shown mounted within the upper box 52 (FIG. 23) of the bike rack housing 50. To install rack 36, slide the rack 36 into the box 52, align a hole in the side of box 52, with a hole in the side of rack 36, and insert a fastener through the aligned holes, such as a bolt or pin 59.

To remove the Bike Rack arm 36, uninstall the bolt or pin 59. Slide the rack 36 out of the box 52.

To fold an upper arm 24 of FIG. 22 down, unscrew the hand-screw head 25A (FIG. 10B) of screw 25A, to remove tension from the rectangular plate 25. The rectangular plate 25 will then be free to rotate horizontally across the arm direction, clearing room to lower the horizontal upper arms 24, into a vertical position outside the vertical lower arms 24

When the upper arm 24 is vertical, the rectangular plate 25 will then be free to rotate horizontally over the arms. Tighten screw 25A, to apply tension to the rectangular plate 25 and secure the upper arms 24 down in a vertical position outside the lower arm 24 folded up.

FIG. 23 is a rear elevation of the bike rack housing 50 atop an upper arm 24. A 2″ internal diameter receiver 52 is sized to accept a bike rack arm 36. A saddle 54 is welded under receiver 52 and is dimensioned to sit astride the upper arm 24. Set screws 58 hold the saddle 54 in track 60 of the upper arm 24.

FIG. 24 is a side elevation thereof. Saddle 54 sits astride a cross section of upper arm 24. The set screw 58 protrudes from the saddle 54, through 54, and into the track 60 of the upper arm 24, so that saddle 54 can't be lifted off track 24.

A bolt 71, or a clevis pin, or a fastener 19 can be inserted:
through hole 76 in the saddle 54,
through another hole 78 in arm 24,
which hole 78 locates the saddle 54,
through an opposite hole 79 in arm 24, and
threaded into front hole 80 in saddle 54.

### REFERENCE NUMERALS

1 hitch mount tube 1

2 Rack generally designated 2.

2A cargo basket 2A

2B cargo basket fence perimetric fence

2C aluminum strip 2C, about (3″ high, bent into several sections:
2D front left section 2D,
2E left angled rear section 2E,
2F rear section 2F,
2G rear angled right section 2G, and
2H right section 2H.
3A Bend 3A is between front left section 2D and left-angled rear section 2E.
3B Bend 3B is between left angled rear section 2E and rear section 2F.
Bend 3C is between rear section 2F, rear angled right section 2G.
Bend 3D is between rear angled right section 2G, and
right section 2H.
3 Back

aluminum hitch receiver tube 6

hole 6M in hitch 8

holes 6H 6i 6J 6K

vehicle 7

existing vehicle receiver hitch 8

vehicle rear seats 9

Storage space 9B

extension deck 10

2″ aluminum hitch sleeve 11

⅝″ hole 12

⅝″ threaded hole 13

angled cut to clear rear seats 14

alignment pins 15

alignment holes 16

16B Front lower surface

17 removable fishing rod holder 17

18—Quick drop in pin with cotter pin

19—⅝″ Partially Threaded anti-rattle Hitch pin with cotter pin
19A hex-head
19B threads
19H hole
19S cotter pin

20—Tesla model x rear trunk floor panel

21—Cargo rack deck (surface 1 or surface 2)

22—4 arm Multi use accessory carrier
23—Arm accessory bracket

24—Slotted track for attaching accessories

28—Hinge bolt

29—Ski/snowboard holder with track mount (supplied by other)

30—Spring loaded pop pin

31—⅜″ locking pin

32—Universal cargo basket

33—Tie down holes for straps

34—Cargo bag (supplied by other)

35—Cargo tie down straps (supplied by other)

36—Bike rack mount arm

37—Rectangular mounting tube

38—Insert for slotted track

39—Bike mount with strap (by other)

40—Support gusset

1. A cargo rack system for a vehicle (7) with a trailer hitch (8), said system comprising:
a rack (2);
said rack (2) has a sliding hitch receiver bar (1);
said rack is reversible front to back on said sliding hitch receiver bar (1).

2. A cargo rack system according to claim 1 further comprising an extension deck (10);
said extension deck (10) having an aluminum hitch sleeve (11);
said extension deck (10) being affixable by the aluminum hitch sleeve (11): either directly to the trailer hitch (8), or being affixable by the aluminum hitch sleeve (11) to an end of said rack, said end of said rack (2) facing away from said vehicle (7).

3. The cargo rack system according to claim 2 in which:
the rack (2) comprises a hollow square-sectioned tube (6) dimensioned to slidably fit the sliding hitch receiver bar (1) and the aluminum hitch sleeve (11) within said hollow square-sectioned tube (6); and within said sliding hitch receiver bar (1), said aluminum hitch sleeve (11) having holes for being pinned to matching holes:
in the hollow square-sectioned tube (6); and
in the hitch (8).

4. The cargo rack system according to claim 3 in which each of said holes are pinned by one of a plurality of fasteners (19), and each said fastener is attached by screwing threads (19C) clockwise with a hex head (19A) into matching threads in an aligned hole (6M), said fastener (19) has an end hole (19H) which is far enough from the hex head (19A) so that the end hole (19H) protrudes from the hitch receiver tube (6), and an S-cotter-pin (19S) has been inserted into the end hole (19H), as a preventer, holding said fastener (19) from unscrewing and falling out.

5. A cargo rack system according to claim 1 in which the rack (2) comprises
a cargo basket (2A), defined by an aluminum floor (21) and a substantially vertical fence (2B);
the fence (2B) comprises an aluminum strip (2C), bent into several sections, divided by a plurality of bends in the aluminum strip (2C);
the fence (2B) is welded to the aluminum floor (21).

6. A cargo rack system according to claim 4 in which the extension deck (10) has an aluminum floor (21) welded to a second aluminum fence (2M to 2S).

7. A cargo rack system according to claim 2 in which the extension deck (10) has an aluminum floor (21) welded to the second aluminum fence (2M to 2S).

8. A cargo rack system according to claim 7 in which:
the rack (2) is sized to fit inside the vehicle in a cargo space provided within said vehicle.

9. A cargo rack system according to claim 7 in which a second hitch (8) is provided at a front of the vehicle (7), and the rack and extension are mountable by the second hitch.

10. A cargo rack system according to claim 7 in which a fishing rod holder (17 or 18) is mountable to the rack (2).

11. A cargo rack system according to claim 7 in which a fishing rod holder (17 or 18) is mountable to the extension deck (10).

12. A cargo rack system according to claim 1 in which:
a four-arm multi-use accessory carrier (22) includes a mounting box (22A), sized to fit within a receiver tube (6);
the mounting box (22A) is slid into the hitch receiver tube (6) and secured thereto by an anti-rattle hitch pin (19) through a hole in the receiver tube (6); and threaded by threads (19C) into a threaded hole (13) in the mounting box (22A), and secured by a cotter pin (19S).

13. A cargo rack system according to claim 12 in which:
the four-arm multi-use accessory carrier (22) includes an upright (22B) is secured to the box (22A) by the pin (19) through the threaded hole (28), and further braced up by a pair of side plates (28A), and by a pin (35) of a pin assembly (31) through a pair of alternate holes (35A) through the side plates (28A);
a latch (36) then secures the pin (35) in the threaded hole (28);
a pair of braces (25) are frictionally secured by adjustable bolts (28) to the upright (22B) and allow the arms (24) to be positioned and angled as needed;
on the upright (22B) and the arms (24) can be mounted:
a ski rack;
a fishing pole adapter (17);
a cargo bag; or
a bike rack mount arm (36);
the arms fold up in the bottom hinges; and
the four-arm multi-use accessory carrier (22) lays flat and stores inside a cargo basket (28).

14. A cargo rack system according to claim 12 in which the four-arm multi-use accessory carrier (22) is mounted between the cargo basket and the vehicle, securing a bicycle to the cargo basket and protecting the vehicle from the bicycle.

15. A cargo rack system for a vehicle (7) with a trailer hitch (8), said system comprising:
a rack (2K);
said rack (2K) has a sliding hitch receiver bar (1);
said rack is reversible front to back on said sliding hitch receiver bar (1);
an extension deck (10);
said extension deck (10) having an aluminum hitch sleeve (11);
said extension deck (10) being affixable by the aluminum hitch sleeve (11): either directly to the trailer hitch (8), or being affixable by the aluminum hitch sleeve (11) to an end of said rack, said end of said rack (2) facing away from said vehicle (7);
the rack (2) comprises a hollow square-sectioned tube (6) dimensioned to slidably fit the sliding hitch receiver bar (1) and the aluminum hitch sleeve (11) within said hollow square-sectioned tube (6); and within said sliding hitch receiver bar (1), said aluminum hitch sleeve (11) having holes for being pinned to matching holes:
in the hollow square-sectioned tube (6); and
in the hitch (8);
each of said holes are pinned by one of a plurality of fasteners (19), and each said fastener is attached by screwing threads (19B) clockwise with a hex head (19A) into matching threads in an aligned hole (6M), said fastener (19) has an end hole (19H) which is far enough from the hex head (19A) so that end hole (19H) protrudes from the hitch receiver tube (6), and an S-cotter-pin (19S) has been inserted into end hole (19H), as a preventer, holding fastener (19) from unscrewing and falling out;
the rack (2) comprises
a cargo basket (2A), defined by an aluminum floor (21) and a substantially vertical fence (2B);
the fence (2B) comprises an aluminum strip (2C), bent into several sections, divided by a plurality of bends in the aluminum strip (2C);
the fence (2B) is welded to the aluminum floor (21);
the extension deck (10) has an aluminum floor (21) welded to an aluminum fence (10C);
the rack (2) is sized to fit inside the vehicle in a cargo space provided within said vehicle.
a fishing rod holder (17 or 18) is mountable to the rack (2) or to
the extension deck (10).
a four-arm multi-use accessory carrier (22) includes a mounting box (22A), sized to fit within the receiver tube (6);
the mounting box (22A) is slid into the hitch receiver tube (6) and secured thereto by an anti-rattle hitch pin (19) through a hole in the hitch receiver (6); and threaded by threads (19C) into threaded hole (13) in the mounting box (22A), and secured by cotter pin (19S);
the four-arm multi-use accessory carrier (22) includes the upright (22B) is secured to the box (22A) by the pin (19) through the threaded hole (28), and further braced up by the side plates (28A), and by the pin (35) of pin assembly (31) through a pair of alternate holes (35A) through the side plates (28A);
latch (36) then secures the pin (35) in the hole (28A);
a pair of braces (25) are frictionally secured by adjustable bolts (28) to the upright (22B) and allow the arms (24) to be positioned and angled as needed;
on the upright (22B) and the arms (24) can be mounted:
a ski rack;
a fishing pole adapter (17);
a cargo bag; or
a bike rack mount arm (36);
the arms fold up in the bottom hinges; and
the four-arm multi-use accessory carrier (22) lays flat and stores inside the cargo basket (28).

16. A method of using the rack including:
installing the rack comprising the steps of:
sliding out the retractable hitch mount (1) from the cargo carrier;
inserting the retractable hitch mount 1 into a vehicle receiver hitch (8);
securing the retractable hitch mount 1 into the vehicle receiver hitch (8) by inserting an anti-rattle hitch pin (19) through a hole (12) in the vehicle receiver hitch (8); and
screwing the anti-rattle hitch pin (19) into a threaded hole (13) in the retractable hitch mount tube 1.

17. A method according to claim 16 including
a method of uninstalling the rack including the steps of:
un-screwing the anti-rattle hitch pin (19) from the threaded hole (13) in the retractable hitch mount tube (1);
sliding the retractable hitch mount tube (1) out of the vehicle receiver hitch (8);
sliding the retractable hitch mount (1) into an aluminum hitch receiver tube (6), thus reducing the footprint of the rack (2); and
storing the rack (2) snugly in a space (9B) behind a rear-most seat (9).

18. A method according to claim 17 in which the method of uninstalling may further include the steps of:
using the rack (2) to replace the car's rear trunk floor panel (20), and
lifting the rack (2);
lifting the rack (2) the same way as a lifting the vehicle's floor panel (20), to yield access to the car's lower storage bin.
